(19) United States
(12) Patent Application Publication
(10) Pub. No.: US 2025/0040745 A1
(43) Pub. Date: Feb. 6, 2025

(54) LIQUID HEATING APPLIANCES

(71) Applicant: Strix (China) Limited, Guangzhou (CN)

(72) Inventors: Marc Collinson, Ronaldsway (GB); Guoshun Zhong, Guangzhou (CN)

(21) Appl. No.: 18/723,591

(22) PCT Filed: Dec. 22, 2022
(86) PCT No.: PCT/GB2022/053379

§ 371 Date: Jun. 24, 2024

(30) Foreign Application Priority Data
Dec. 22, 2021 (CN) 202111582579.3
Dec. 22, 2021 (CN) 202123277182.1
Feb. 21, 2022 (GB) 2202266.9

(51) Int. Cl. A47J 27/21; H05B 6/06; H05B 6/10

(52) U.S. Cl. CPC A47J 27/21175; A47J 27/21008; H05B 6/06; H05B 6/108

(57) ABSTRACT

A liquid heating appliance includes a container defining a liquid heating compartment, a lid for covering the container, and a heater for heating liquid within the compartment. The lid defines a recessed receiving chamber for receiving a volume of liquid, and the receiving chamber includes a non-return filling valve. In a filling mode of the appliance, the filling valve allows liquid to flow from the receiving chamber into the liquid heating compartment. In a heating mode of the appliance, the filling valve prevents fluid from flowing from the liquid heating compartment into the receiving chamber.

The present invention relates to liquid heating appliances.

Liquid heating appliances, such as kettles, are common in many households. Conventional kettles comprise a liquid heating compartment for receiving liquid, and a heater for increasing the temperature of the liquid.

Kettles are typically used to heat liquid up to boiling point, which causes the liquid to evaporate into steam. It may be desirable to prevent this steam from leaving the appliance, whether for operational reasons (e.g. in order to activate a steam sensor to turn off the appliance) or owing to safety concerns. Thus, conventional kettles are provided with a lid and a spout filter to prevent steam from escaping the liquid heating compartment.

Although some kettle designs do lend themselves to being filled via the spout, this is not always practical (as the spout might be too small) or desirable (as a large spout might adversely affect the appearance of the kettle). Hence, for kettles where spout filling is not feasible, this means that a user wishing to fill the kettle with liquid to be heated must first open or remove the lid, and then close or replace it again once the kettle has been filled. As a result, the time taken to fill the appliance is increased, and the ease with which a user can perform this task is reduced.

The Applicant has appreciated that there is a need for a liquid heating appliance, such as a kettle, that can be filled quickly and straightforwardly by a user.

The present invention aims to provide an improved appliance and when viewed from a first aspect the present invention provides a liquid heating appliance comprising:
a container defining a liquid heating compartment, a lid arranged over the container to cover the liquid heating compartment, and a heater operable to heat liquid within the liquid heating compartment;
wherein the lid defines a receiving chamber for receiving a volume of liquid, and the receiving chamber comprises a filling valve,
wherein the filling valve is arranged, in a filling mode of the liquid heating appliance, to operate to allow liquid to flow from the receiving chamber into the liquid heating compartment and, in a heating mode of the appliance, to operate to substantially prevent fluid from flowing from the liquid heating compartment into the receiving chamber.

Thus, a user of the appliance of the present invention can fill the appliance with a liquid to be heated by filling the receiving chamber and the filling valve is arranged to allow the liquid to flow from the receiving chamber into the liquid heating compartment during the filling mode. The receiving chamber in the lid may be easier to fill than attempting to fill via a spout, and liquid can flow straight into the liquid heating compartment without requiring user intervention (such as operating a hinged lid). During the heating mode (at least), the filling valve is arranged to substantially prevent the passage of fluid, such as steam, in the reverse direction. This means that steam generated in the liquid heating compartment is not able to easily escape via the receiving chamber in the lid during the heating mode (i.e. steam escape is prevented or baffled). In the heating mode of the appliance, the valve may be arranged to substantially prevent the flow of both liquid and steam from the liquid heating compartment to the receiving chamber through the filling valve. Thus, if the appliance is tilted during the heating mode then hot liquid also cannot escape via the receiving chamber in the lid. The lid therefore acts as a closed cover for the liquid heating compartment at least during the heating mode, as with a conventional kettle.

It should be understood that the filling mode and the heating mode may not be mutually exclusive. The filling valve operates to allow liquid to flow into the liquid heating compartment at least during the filling mode. In some embodiments, the filling valve may also allow liquid to flow into the liquid heating compartment during the heating mode. The filling valve operates to substantially prevent fluid from flowing from the liquid heating compartment into the receiving chamber at least during the heating mode. In some embodiments, the filling valve may also operate in the same way during the filling mode. It may be preferable that, in the filling mode of the appliance, the filling valve is arranged to substantially prevent steam from flowing from the liquid heating compartment into the receiving chamber. This provides a safety benefit as a user pouring liquid into the receiving chamber should not be exposed to a scalding risk. For example, the filling valve may comprise a non-return valve. The non-return valve may comprise a slit valve or a flap valve, as is described further below.

In some embodiments, the filling valve operates selectively such that the filling mode and the heating mode are mutually exclusive. For example, the filling valve operates to be selectively open in the filling mode and selectively closed during the heating mode. This means that the valve responds to the current mode of operation of the appliance, although being selectively open in the filling mode may allow some steam (e.g. from previously heated liquid in the compartment) to come into contact with a user when filling the receiving chamber.

In some embodiments, the filling valve comprises a valve aperture and a valve closure member. The valve aperture may be provided in a floor of the receiving chamber. The valve aperture may be selectively closed by movement of the closure member to block the valve aperture. In some examples, movement of the closure member may be actuated automatically when/before the heating mode begins. In some other examples, movement of the closure member may be actuated manually when/before the heating mode begins. In such examples, a single manual action may initiate the heating mode as well as actuating movement of the closure member. For example, the closure member may be provided on a plunger which is manually moveable at (or before) the start of the heating mode. The appliance may include a plunger e.g. for lowering an infusion device into the liquid heating compartment, or for moving a ferromagnetic heating plate within the liquid heating compartment. This may be vertical plunger passing through the valve aperture in the lid, as is described in more detail below.

In some embodiments, the appliance may comprise a non-return valve as well as a filling valve comprising an aperture and a closure member (e.g. selectively closed by operating a plunger). This can improve the safety of the appliance by reducing the risk of a user's hand being scalded by steam when movement of the closure member is actuated manually.

In various embodiments, the filling valve is or includes a non-return valve. This is considered novel and inventive in its own right, and thus when viewed from a further aspect the present invention provides a liquid heating appliance comprising:
a container defining a liquid heating compartment, a lid arranged over the container to cover the liquid heating compartment, and a heater operable to heat liquid within the liquid heating compartment;
wherein the lid defines a receiving chamber for receiving a volume of liquid, wherein the receiving chamber is a recessed feature of the lid and the receiving chamber comprises a non-return filling valve,
wherein the non-return filling valve is arranged, in a filling mode of the liquid heating appliance, to operate to allow liquid to flow from the receiving chamber into the liquid heating compartment and, in a heating mode of the appliance, the non-return filling valve is arranged to operate to substantially prevent fluid from flowing from the liquid heating compartment into the receiving chamber.

Preferably the non-return valve is arranged to allow liquid to flow from the receiving chamber into the liquid heating compartment when a threshold pressure differential across the valve is reached. Preferably the pressure differential is provided by the weight of the liquid in the receiving chamber. The non-return valve is preferably biased closed, such that the valve is closed when the pressure differential across the valve is less than the threshold.

The non-return valve may comprise any suitable type of one-way check valve. Preferably the non-return valve comprises a slit valve. The valve may comprise a resilient material including one or more slits. The resilient material may include two slits that cross each other at right angles. Preferably the one or more slits are arranged to open (i.e. to widen) when the weight of the volume of liquid in the receiving chamber is sufficient to exceed the threshold pressure differential across the valve. The (e.g. resilient material of the) slit valve may be made of an elastically deformable thermoplastic material. The (e.g. resilient material of the) slit valve may be made of an elastomeric material such as silicone, fluorosilicone, neoprene, EPDM, nitrile or other synthetic rubber. For example, the slit valve may be made from food-grade silicone.

In some embodiments the slit valve comprises a trough. Preferably the resilient material of the slit valve defines a trough. The one or more slits of the non-return valve are preferably defined in the base of the trough. The provision of a trough allows liquid within the receiving chamber to pool around the slit valve, thereby encouraging the flow of liquid through the slit valve. This also allows the threshold pressure differential to be reached more quickly, as the weight of the liquid will be concentrated above the slit valve.

In some embodiments the filling (e.g. non-return) valve comprises a trough, e.g. a trough for receiving a smaller volume of liquid from the receiving chamber. The filling valve preferably comprises an opening in the base of the trough. The provision of a trough allows liquid within the receiving chamber to pool around the filling valve, thereby encouraging the flow of liquid through the filling valve. This also allows the threshold pressure differential to be reached more quickly, as the weight of the liquid will be concentrated above the filling valve. In such embodiments, the non-return valve is arranged to allow liquid to flow from the trough into the liquid heating compartment when a threshold pressure differential across the valve is reached, wherein the pressure differential is provided by the weight of the liquid in the trough. This helps to ensure that the receiving chamber can drain fully.

The trough may comprise a U-shaped (or semi-circular) cross-section, a V-shaped cross-section or a Y-shaped cross-section. These shapes help to provide the non-return function of the valve, as a greater negative pressure differential (i.e. a pressure differential encouraging flow in the reverse direction of the non-return valve) is required in order to force the one or more slits to widen. More generally, these shapes help to provide the non-return function of the valve, as a greater negative pressure differential is required in order to force the non-return valve to open.

In some embodiments, the trough is sized to accommodate between 1 ml and 20 ml of liquid, e.g. between 5 ml and 15 ml, e.g. approximately 10 ml.

The container may be made of any suitable or desired material. For example, the container may be substantially made of glass, plastic, or metal materials. In some embodiments, at least a portion of the container is glass. In some embodiments, a portion of the container is plastic. The container may comprise a glass lower portion and a plastic upper portion. The container may be transparent or semi-transparent. In some embodiments, the appliance comprises a decorative layer extending around a portion of the container. The decorative layer may extend around an upper portion of the container, for example a plastic upper portion. The decorative layer may comprise a wrap of stainless steel, or any other suitable or desired material.

In some embodiments, the appliance may comprise a handle for lifting the appliance. The handle may extend from a portion (e.g. an upper portion) of the container. For example, the appliance may comprise a glass lower portion and a plastic upper portion with a plastic handle extending from the upper portion. The plastic handle may be L-shaped or C-shaped.

Preferably the container defines a top opening configured to receive the lid. Preferably the top opening is the top of the liquid heating compartment. Preferably the lid is arranged to close the liquid heating compartment (e.g. and to close the top opening). Preferably the lid is removable. This means that the receiving chamber is removable from the container. The top opening (e.g. and, thus, the lid) may be circular. The lid may be made of any suitable or desired material. Preferably, the lid is plastic. Thus the receiving chamber may be made of plastic, even though the container (e.g. a lower portion thereof) may be made of glass. These plastic parts can help to reduce the weight of the appliance.

In some embodiments, the container comprises a spout. The spout is preferably in fluid communication with the liquid heating compartment. This allows liquid to be dispensed from the liquid heating compartment, e.g. after the liquid has been heated. The liquid heating appliance optionally takes the form of a jug, e.g. the container including a spout at one side and a handle at an opposite side.

The receiving chamber is preferably wholly defined by the lid. Preferably the receiving chamber is integrally formed with the lid. In other words, the lid may be a single piece defining the receiving chamber. Preferably the lid is removable and hence the receiving chamber is always removed with the lid.

Preferably the receiving chamber extends into the appliance from an upper surface of the lid. Thus, the receiving chamber is preferably a recessed feature of the lid. Preferably the receiving chamber is uncovered. This allows a user to fill the receiving chamber with liquid directly (e.g. from a tap), without being required to remove or move any components of the appliance. Preferably the receiving chamber extends downwards from an aperture defined by the upper surface of the lid. The receiving chamber is preferably at least 20 mm deep, e.g. at least 30 mm deep, e.g. at least 40 mm deep, e.g. at least 50 mm deep, e.g. at least 60 mm deep, e.g. at least 70 mm deep, e.g. at least 80 mm deep, e.g. at least 90 mm deep, e.g. at least 100 mm deep. The depth of the receiving chamber may be at least 20% or 30% of the height of the appliance. The depth of the receiving chamber may be approximately 40% of the height of the appliance. A deep receiving chamber helps to avoid liquid splashing out of the receiving chamber when the receiving chamber is being filled.

The lid may include a funnelled (e.g. upper) portion defining the receiving chamber. The funnelled portion i.e. funnel may be shaped to direct liquid towards the filling valve. The lid may comprise a floor, defining the base of the receiving chamber. In some embodiments the lid includes a funnel for directing liquid down towards a funnel floor, wherein the funnel floor comprises the filling valve. Preferably the filling valve is arranged in the floor of the lid (e.g. in the funnel floor). The filling valve may be arranged in the centre of the floor (e.g. funnel floor). However, preferably the filling valve is arranged off-centre in the floor (e.g. funnel floor). This allows other lid features (such as a plunger or knob) to be positioned centrally in the appliance. Preferably at least a portion (e.g. all) of the floor (e.g. funnel floor) is inclined such that liquid is directed towards the filling valve.

In some embodiments, the funnelled portion of the lid, which defines the receiving chamber, comprises an inclined funnel floor that slopes downward towards the filling valve. Preferably the filling valve is arranged at a low point of the funnel floor such that liquid flowing down the slope of the inclined funnel floor is directed into the filling valve. As mentioned above, preferably the filling valve comprises a trough. Preferably the funnel floor is inclined such that liquid is directed towards the trough of the filling valve, e.g. to fill the smaller volume of the trough. The slope of the funnel floor in combination with pooling in the trough assists in directing liquid through the filling valve.

The liquid heating compartment is preferably arranged below the receiving chamber. The volume of the liquid heating compartment may be greater than the volume of the receiving chamber.

In some embodiments, the heater comprises an electric resistance heating element. The electric resistance heating element may be integrated into a base of the container. Preferably the appliance comprises a thermally sensitive actuator arranged to switch off the heater when the thermally sensitive actuator triggers. The thermally sensitive actuator may be an overheat sensor (e.g. mounted to detect when the temperature of the heater exceeds a predefined temperature) or a boiling sensor (e.g. mounted to detect the temperature of the liquid in the liquid heating compartment or to detect steam generated in the liquid heating compartment). In some other embodiments, the heater comprises a ferromagnetic heating plate for inductive heating when the appliance is placed on an energised induction hob.

In some embodiments, the appliance may comprise a plunger arranged to extend into the liquid heating compartment. The plunger may extend through the lid into the liquid heating compartment. This is considered novel and inventive in its own right, and thus when viewed from a further aspect the present invention provides a liquid heating appliance comprising:
a container defining a liquid heating compartment, a lid arranged over the container to cover the liquid heating compartment, and a heater operable to heat liquid within the liquid heating compartment;
wherein the lid defines a receiving chamber for receiving a volume of liquid, and the receiving chamber comprises a filling valve,
wherein the filling valve is arranged, in a filling mode of the liquid heating appliance, to operate to allow liquid to flow from the receiving chamber into the liquid heating compartment and, in a heating mode of the appliance, the filling valve is arranged to operate to substantially prevent fluid from flowing from the liquid heating compartment into the receiving chamber; and
wherein the liquid heating appliance further comprises a plunger, arranged to extend through the lid into the liquid heating compartment and moveable vertically relative to the container between a lowered position and a raised position, wherein the plunger is arranged in the lowered position during the heating mode of the appliance, and arranged in the raised position during the filling mode of the appliance.

The plunger may operate independently of the filling valve in some embodiments. The lid may define an aperture through which the plunger is arranged to extend. As mentioned above, in some embodiments this aperture is the valve aperture of the filling valve and the plunger carries a closure member for the filling valve. The plunger may extend through the receiving chamber into the liquid heating compartment. In some embodiments, the plunger is arranged to extend vertically and centrally in the appliance. As mentioned above, in some embodiments the plunger is arranged to extend through an aperture arranged centrally in a floor of the receiving chamber and into the liquid heating compartment, and the filling valve is arranged off-centre in the floor of the receiving chamber. This enables the liquid heating compartment to be filled easily despite the presence of the plunger.

Preferably the plunger is moveable vertically relative to the container. The plunger may be moveable between a lowered position and a raised position. Such a plunger may find a variety of uses when preparing beverages from a heated liquid.

In some embodiments, an infusion device such as a perforated container for infusion beverage material (such as tea leaves, coffee grounds, or other soluble beverage material) may be mounted to the plunger at a lower end of the plunger. In some embodiments, a stirrer or agitator may be mounted to the plunger at a lower end of the plunger, for example to make a frothy milk beverage.

In some embodiments, a ferromagnetic heating plate may be mounted (e.g. welded) to the plunger at a lower end of the plunger. For example, the plunger extends perpendicularly from the surface of the ferromagnetic heating plate. In the lowered position, the ferromagnetic heating plate is preferably adjacent a base of the container. In the raised position, the ferromagnetic heating plate is preferably moved away from the base of the container. Preferably when, in use, the appliance is placed on an energised induction hob, the lowered position is such that the ferromagnetic heating plate is close enough to the induction hob to be inductively heated by the induction hob, and the raised position is sufficiently distant from the induction hob such that the ferromagnetic heating plate is not heated by the induction hob.

A user may manually move the plunger up and down to change the position of the ferromagnetic heating plate or infusion device. Optionally, the appliance may comprise a lifting mechanism for automatically moving the plunger (and hence e.g. the ferromagnetic heating plate or infusion device) from the lowered position into the raised position, for example in response to a timer or temperature sensor.

In some embodiments, the appliance further comprises a thermally sensitive actuator and a lifting mechanism arranged to automatically move the ferromagnetic heating plate from a lowered position into a raised position when triggered by the thermally sensitive actuator. The thermally sensitive actuator may be an overheat sensor (e.g. mounted to detect when the temperature of the ferromagnetic heating plate exceeds a predefined temperature) or a boiling sensor (e.g. mounted to detect the temperature of the liquid in the liquid heating compartment or to detect steam generated in the liquid heating compartment). This means that inductive heating of the ferromagnetic heating plate will cease automatically in response to overheat and/or boiling being detected. Furthermore, in those embodiments wherein the plunger carries the closure member of the filling valve, the filling valve is selectively opened when the heating mode ceases.

Preferably the filling/heating mode of the appliance is determined by the position of the plunger. Preferably the plunger is arranged in the lowered position during the heating mode of the appliance. Preferably the plunger is arranged in the raised position during the filling mode of the appliance.

As mentioned above, the plunger may comprise a closure member of the filling valve. The valve closure member may be arranged to selectively close the filling valve in the receiving chamber when the plunger is in the lowered position, and to selectively open the filling valve in the receiving chamber when the plunger is in the raised position. The closure member may comprise a seal for substantially sealing the valve aperture. The closure member may comprise an O-ring or a grommet arranged around the plunger. The closure member may comprise a baffle arrangement mounted on the plunger.

Preferably the closure member comprises a resilient material. This allows the closure member to provide an effective seal between the liquid heating compartment and the receiving chamber. Preferably the resilient material is heat resistant to at least 60° C., e.g. to at least 80° C., e.g. to at least 100° C.

Preferably the closure member is configured to seal the valve aperture of the filling valve at least under a steam pressure in the liquid heating compartment of 1.2 bar, 1.4 bar, 1.6 bar, 1.8 bar, or 2.0 bar.

In some embodiments, as discussed above, the filling valve includes an aperture and a valve closure member that is carried by the same plunger as a ferromagnetic heating plate, resulting in the filling valve being selectively operated in dependence on the inductive heating mode. In some embodiments, the valve closure member may be mechanically connected to an electrical switch for operating electrical components of the appliance, such as an electrical heater. Thus, such components can be operated in dependence upon the mode of the appliance. For example, the electrical heater may be configured to turn on when the filling valve is selectively closed by the valve closure member, i.e. in the heating mode of the appliance, and to turn off when the valve is open, i.e. in the filling mode of the appliance.

In the filling mode of the appliance, the valve may be arranged to permit steam to flow from the liquid heating compartment into the receiving chamber. For example, after the user has boiled liquid using the appliance, residual steam may remain in the liquid heating compartment when it comes to refilling the appliance with liquid. This residual steam may be permitted to flow through the valve from the liquid heating compartment into the receiving chamber when the mode of the appliance is changed from “heating” to “filling” (e.g. by selectively opening the valve).

There will now be described some further features of the lid of the liquid heating appliance which can be applied regardless of whether a plunger is present or not.

In some embodiments, the lid comprises a lifting feature for grasping and lifting to remove the lid from the container. The lifting feature may be positioned in the receiving chamber so as to indicate to a user that the lid should only be removed when the receiving chamber is empty (otherwise liquid could spill out). This may be beneficial for cleaning purposes, for example, as it can allow the user to remove the lid easily and clean the receiving chamber and/or the exposed liquid heating container. The lifting feature may protrude from a surface of the lid, e.g. from a surface of the receiving chamber. Preferably the lifting feature protrudes from a floor of the lid (e.g. from the base of the receiving chamber).

The lifting feature may be movable, e.g. a hinged handle. However, preferably the lifting feature is static, e.g. a knob. Preferably the lifting feature is separate from, and located away from, the filling valve so as to facilitate the flow of liquid in the receiving chamber towards the filling valve. As mentioned above, the lifting feature may be arranged centrally in the lid (e.g. arranged centrally in the floor of the lid) while the filling valve is arranged off-centre (e.g. in the floor of the lid).

The appliance may comprise a manual intervention part for interrupting the operation of the heater. The plunger may comprise the manual intervention part. The valve closure member may comprise the manual intervention part. The manual intervention part may be arranged to operate the lifting mechanism to move the plunger into the raised position. The manual intervention part may be arranged to switch off the heater.

Some preferred embodiments of the present invention will now be described, by way of example only, and with reference to the accompanying drawings, in which:

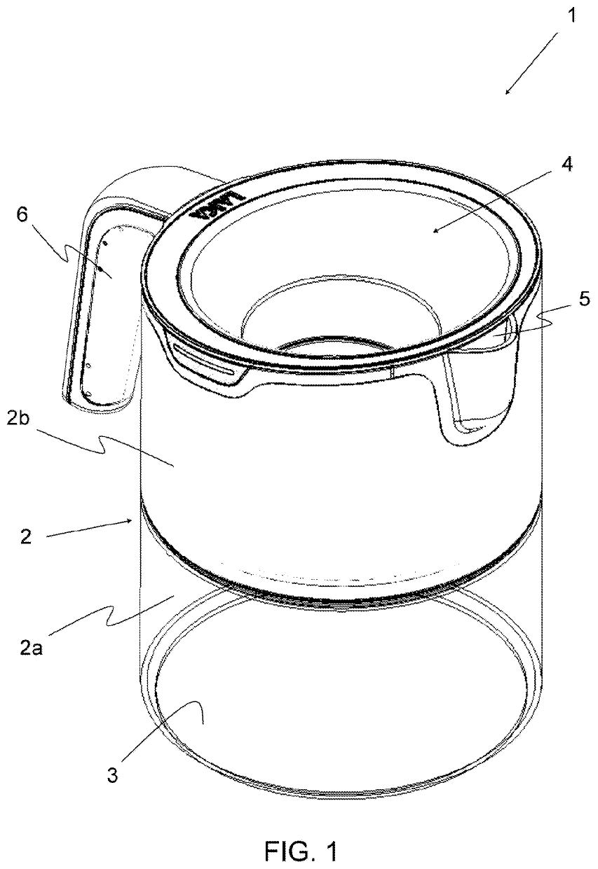

FIG. 1 shows a perspective view of a liquid heating appliance in accordance with an embodiment of the present invention;

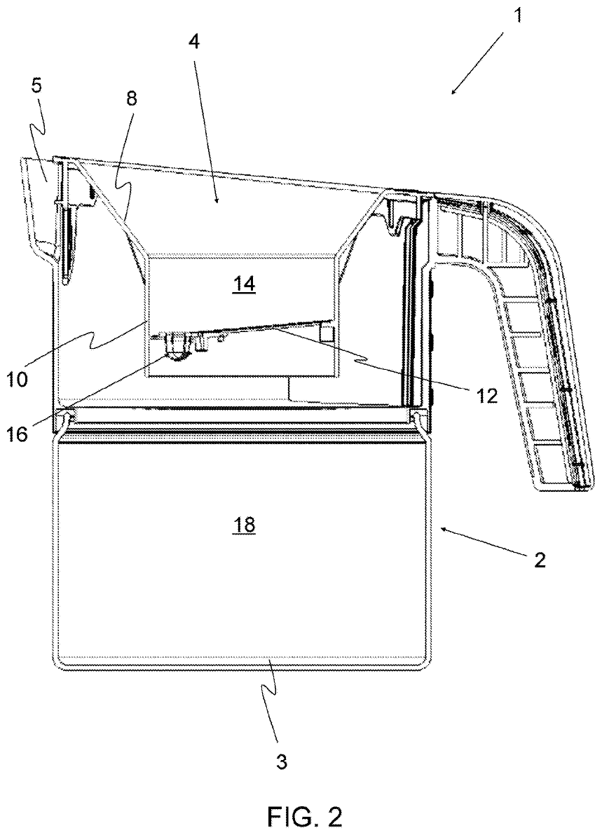

FIG. 2 shows a cross-sectional side view of the appliance seen in FIG. 1;

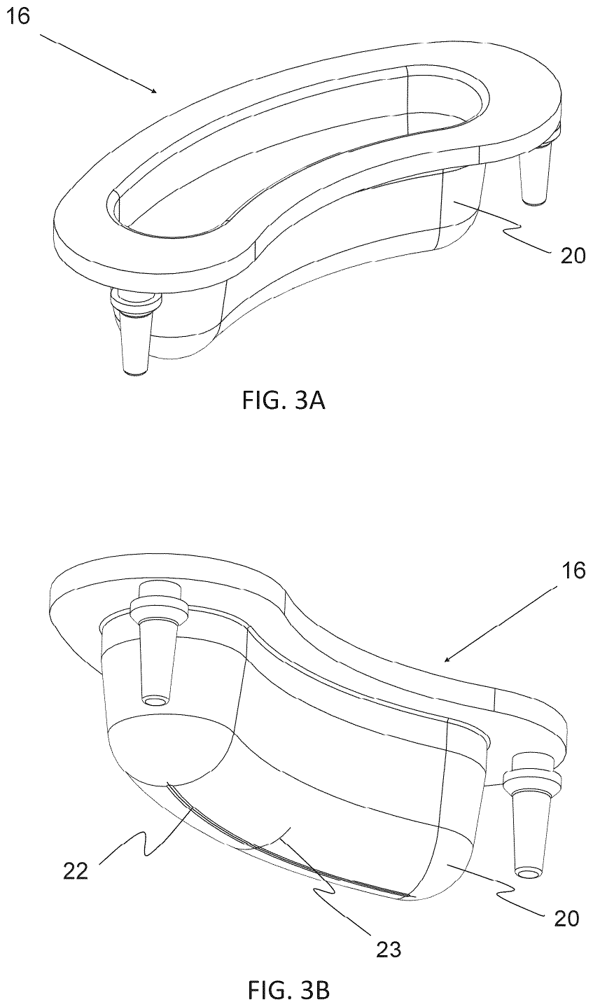

FIG. 3a shows an upper perspective view of the valve of the appliance seen in FIG. 1;

FIG. 3b shows a lower perspective view of the valve of the appliance seen in FIG. 1;

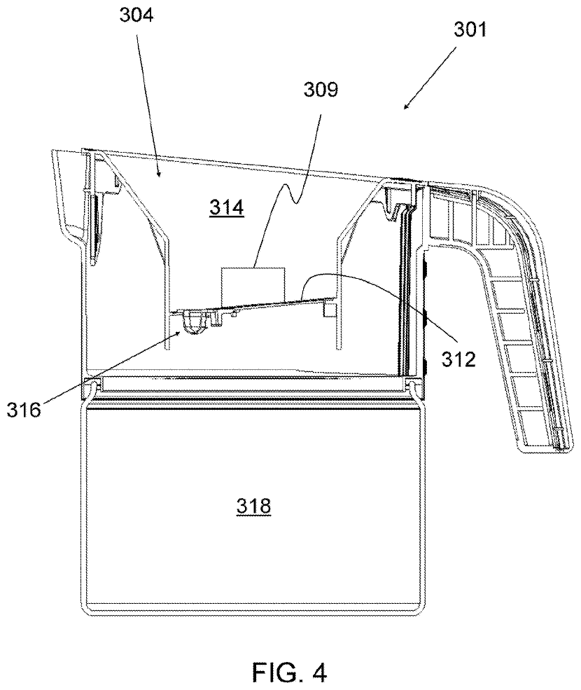

FIG. 4 shows a cross-sectional side view of a liquid heating appliance in accordance with another embodiment of the present invention;

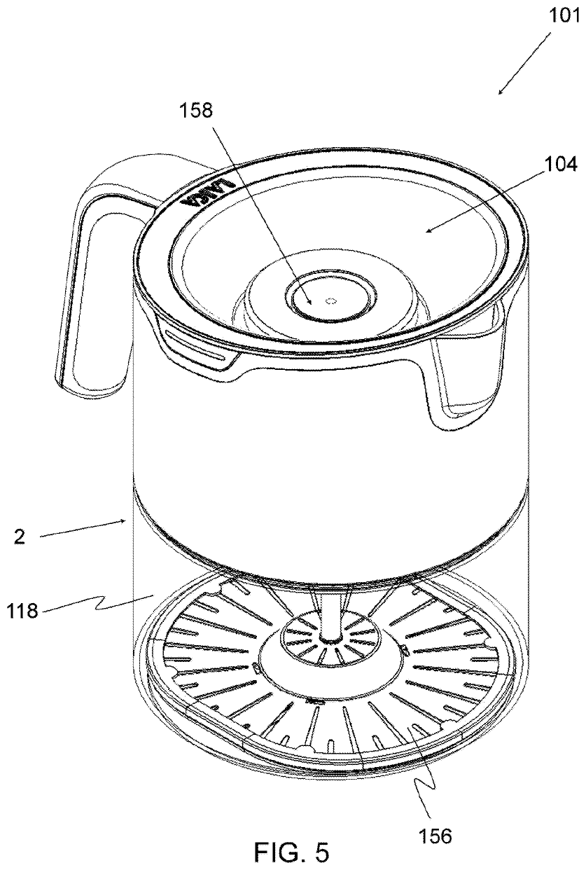

FIG. 5 shows a perspective view of a liquid heating appliance in accordance with another embodiment of the present invention;

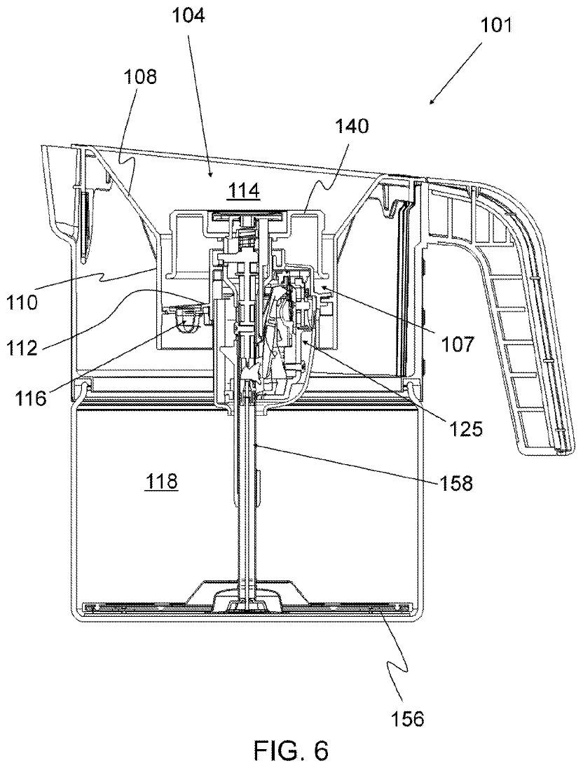

FIG. 6 shows a cross-sectional side view of the appliance seen in FIG. 5;

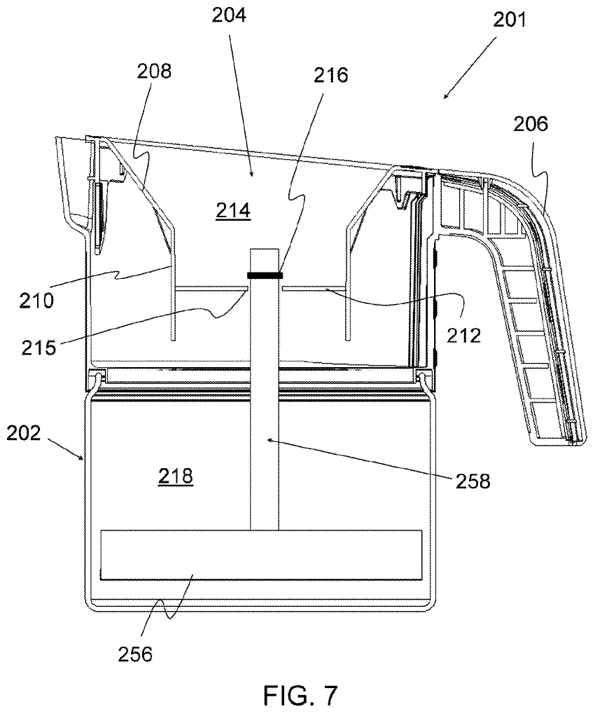

FIG. 7 shows a cross-sectional side view of a liquid heating appliance in accordance with another embodiment of the present invention.

FIG. 1 shows a perspective view of a liquid heating appliance 1 for heating liquid, hereinafter the appliance 1, in accordance with an embodiment of the invention. The appliance 1 comprises a container 2, comprising a lower portion 2a and an upper portion 2b, a lid 4, and a handle 6 for lifting the appliance 1. The lid 4 is removably fitted within an aperture defined at the upper end of the container 2. The appliance 1 further comprises a spout 5, for dispensing liquid, and a heater 3 arranged within the container 2. In this embodiment, the heater 3 is any suitable type of electrical resistance heater immersed in the container 2 or integrated into its base.

The lower portion 2a of the container 2 is made from transparent glass. The upper portion 2b of the housing 2 is made from plastic. However, a decorative stainless steel wrap extends around the outer surface of the upper portion 2b.

FIG. 2 shows a cross-sectional side view of the appliance 1 of FIG. 1. The lid 4 of the appliance 1 comprises a substantially circular funnel 8, including a funnel wall 10 and a funnel floor 12. The funnel 8 is shaped to direct liquid towards the centre of the appliance 1. The funnel wall 10 is partly conical and then extends vertically downwards around the centre of the funnel 8. Of course the funnel 8 may take an alternative shape, for example the wall 10 continuing in a conical shape to the funnel floor 12 without any vertical portion. In the centre of the funnel 8, the funnel floor 12 is inclined to direct liquid towards a filling valve 16 arranged in the funnel floor 12.

The funnel 8 of the lid 4, including the wall 10 and floor 12, defines a receiving chamber 14 for receiving liquid. The receiving chamber 14 is integrally formed with the lid 4. As can be seen in FIG. 1, the top of the receiving chamber 14 is open (i.e. it is not covered by a lid), which means that a user can easily fill the receiving chamber 14 (e.g. with liquid from a tap) without having to operate manually or remove any components of the appliance 1.

The container 2 defines a liquid heating compartment 18 within the appliance 1 below the funnel 8. The spout 5 of the appliance 1 is in fluid communication with the liquid heating compartment 18, meaning that liquid can be dispensed from the liquid heating compartment 18 through the spout 5.

The heater 3 is arranged within or adjacent to the liquid heating compartment 18 to heat liquid contained within the liquid heating compartment 18. When the temperature of the liquid within the liquid heating compartment 18 is heated to boiling point, the liquid evaporates into steam.

The receiving chamber 14 comprises the filling valve 16 arranged in the funnel floor 12. The funnel floor 12 is inclined downwardly towards the filling valve 16 to direct liquid in the receiving chamber 14 towards the filling valve 16. The filling valve 16 is configured, in a filling mode of the liquid heating appliance, to operate to permit liquid to flow from the receiving chamber 14 into the liquid heating compartment 18, but, in a heating mode of the appliance, to operate to substantially prevent steam generated in the liquid heating compartment 18 from escaping into the receiving chamber 14.

An example of the filling valve 16 is shown in more detail in FIGS. 3a and 3b. In this example the filling valve 16 is a non-return valve in the form of a slit valve.

The slit valve 16 comprises an elastomeric (e.g. silicone) trough 20 that is arranged to receive liquid from the receiving chamber 14. The trough 20 extends downwardly from the funnel floor 12, as can be seen in FIG. 2. A narrow longitudinal slit 22 is provided along the base of the trough 20. A secondary slit 23, shorter than the longitudinal slit 22, is also provided in the base of the trough 20 and bisects perpendicularly the longitudinal slit 22. The slit valve 16 is one example of a non-return valve comprising one or more openings in the base of a trough.

Operation of the non-return valve 16 will now be described. When the receiving chamber 14 is filled with liquid by a user, the liquid is directed generally towards the centre of the appliance 1 by the funnel 8 and the funnel walls 10 of the receiving chamber 14. The liquid then flows down the inclined floor 12 of the lid 4 towards the non-return valve 16. Thus, the trough 20 of the valve 16 begins to fill with liquid.

The sides of the slit 22 are biased together, owing to the resilience of the elastomeric (e.g. silicone) material of the valve 16, thereby normally sealing the liquid heating compartment 18 from the receiving chamber 14. However, when the trough 20 is sufficiently filled with liquid, the weight of the liquid in the trough 20 forces open the slit 22 in the base of the trough 20, thereby allowing liquid to pass through the slit 22 into the liquid heating compartment 18. Liquid is permitted to flow through the slit 22 until the weight of the liquid within the trough 20 is sufficiently low for the sides of the slit 22 to be biased together once again (e.g. when the trough 20 is substantially empty).

The liquid within the liquid heating compartment 18 may then be heated (e.g. to boiling temperature) by the heater 3. This generates steam within the liquid heating compartment 18. As the slit 22 is biased closed, the steam will be prevented from escaping into the receiving chamber 14 by the valve 16. Even if the user were to fill the receiving chamber 14 with sufficient liquid to cause the slit 22 to open, it will be appreciated that any steam present within the liquid heating compartment 18 would be prevented from escaping into the receiving chamber 14 by the flow of liquid into the liquid heating compartment 18.

The trough 20 has a substantially U-shaped cross-section, which facilitates opening of the slit 22 when pressure is applied to the base of the trough 20 from above (i.e. by liquid within the receiving chamber 14), but inhibits opening of the slit 22 when pressure is applied to the base of the trough 20 from below (i.e. by steam within the liquid heating compartment 18).

FIG. 4 shows a cross-sectional side view of an appliance 301 in accordance with a further embodiment of the present invention. The appliance 301 is essentially the same as the appliance 301 shown in FIGS. 1 and 2, except that the lid 304 further comprises a lifting feature 309 that protrudes upwardly from the funnel floor 312.

The lifting feature 309 may be gripped and lifted upwards by a user of the appliance 301, thereby facilitating the removal of the lid 304 from the container 302. The lifting feature 309 is arranged centrally on the funnel floor 312, such that liquid in the receiving chamber 314 can flow around the sides of the lifting feature 309 towards the filling valve 316.

Although the filling valves 16, 316 shown in FIGS. 2, 3a and 3b, and 4 are arranged towards an edge of the funnel floor 12, 312 i.e. off-centre, it will be appreciated that the filling valve 16, 316 may be arranged anywhere in the lid 4, 304 that provides the desired controlled fluid communication between the receiving chamber 14, 314 and the liquid heating compartment 18, 318. For example, the filling valve 16, 316 may be provided in the centre of the funnel floor 12, 312. The lifting feature 309 may also be placed at any suitable or desired location in the lid 304.

However, arranging the filling valve 16, 316 towards an edge of the floor 12, 312 allows a plunger to extend through the centre of the appliance 1, 301. This can be beneficial in a number of types of liquid heating appliances. For example, the plunger may carry an infusion device (such as a container for holding tea leaves) to be lowered into the liquid heating compartment 18, 318. In liquid heating appliances that involve inductive heating, the plunger may carry a ferromagnetic heating plate, which can be lowered towards the base of the appliance 1, 301.

FIG. 5 shows a perspective view of a liquid heating appliance 101 for heating liquid, hereinafter the appliance 101, in accordance with a further embodiment of the invention. The appliance 101 is essentially the same as the appliance 1 shown in FIGS. 1-4, except that the appliance 101 comprises a plunger 158 that extends through the lid 104 into the liquid heating compartment 118 (when the lid 104 is arranged on the container 102). A ferromagnetic heating plate 156 is welded to a lower end of the plunger 158. The plunger 158 is movable vertically to lift the heating plate 156 from an inductive heating position (in which the plate 156 is adjacent the base of the appliance 101, as seen in FIGS. 5-6) and a non-heating position (in which the plate 156 is moved away from the base of the appliance 101, not shown). The appliance 101 does not include a lifting feature as shown in FIG. 4, although the plunger 158 may be used to lift the lid 104 out of the container 102.

When the heating plate 156 is lowered in the heating position and the base of the appliance 101 is placed on an energised induction hob (not shown), a magnetic field is induced that passes through the ferromagnetic heating plate 156, causing the temperature of the heating plate 156 to rise. Liquid within the liquid heating compartment 118 is then heated by the heating plate 156.

FIG. 6 shows a cross-sectional side view of the appliance 101 of FIG. 5. The plunger 158 comprises a push button 140 at its upper end, which is arranged within the receiving chamber 114 defined by the funnel 108, reservoir wall 110 and reservoir floor 112 of the lid 104. The push button 140 allows a user to adjust the vertical position of the plunger 158 and the heating plate 156. The plunger 158 is shown in the heating position, in which the heating plate 156 is lowered such that it is adjacent the base of the appliance 101.

The appliance comprises a lifting mechanism 107 for lifting the plunger 158 and the heating plate 156. The lifting mechanism 107 comprises a steam sensing arrangement 125 that is configured to release a biasing member (not shown) to move the plunger vertically upwards relative to the lid 104 when the liquid within the liquid heating compartment 118 begins to boil. This moves the plunger 158 into the non-heating position, as the heating plate 156 is moved out of the influence of the magnetic field of the induction hob.

The filling valve 116 is positioned towards the edge of the reservoir floor 112 of the lid 104, thereby allowing the plunger 158 and the lifting mechanism 107 to be positioned centrally in the appliance 101.

When the receiving chamber 114 is filled with liquid by a user in the same way as described above, the plunger 158, the lifting mechanism 107 and the push button 140 are arranged such that the liquid can flow around these components towards the valve 116. The plunger 158 extends through an aperture in the floor 112 of the lid 104 that is sealed in order to prevent steam from escaping into the receiving chamber 114 from the liquid heating compartment 118. The filling valve 116, which is illustrated for example as the same slit valve 16 shown in FIGS. 3a and 3b, has an arcuate shape in order accommodate the centrally positioned plunger 158.

FIG. 7 shows a cross-sectional side view of an appliance 201 in accordance with a further embodiment of the present invention. The appliance 201 comprises a container 202, defining a liquid heating compartment 218, a removable lid 204, and a handle 206 for lifting the appliance 201.

The appliance 201 further comprises a plunger 258 that extends through the lid 204 into the liquid heating compartment 218 (when the lid 204 is arranged on the container 202). A device 256 is shown schematically as being mounted to a lower end of the plunger 258. The device 256 can be a beverage infusion device (such as a perforated basket) or a ferromagnetic heating part as described above. Similar to the plunger 158 shown in FIGS. 5 and 6, the plunger 258 is movable vertically to lift the device 256 between a lowered (e.g. inductive heating) position and a raised (e.g. non-heating) position. The plunger 258 is manually moveable by a user of the appliance between the lowered and raised positions, although an automatic lifting mechanism (as described above with reference to FIG. 6) may also be provided.

The lid 204 of the appliance 201 comprises a substantially circular funnel 208, including a funnel wall 210 and a funnel floor 212. The funnel 208, including the wall 210 and the floor 212, defines a receiving chamber 214 for receiving liquid.

The funnel floor 212 defines a central aperture 215 that provides fluid communication between the receiving chamber 214 and the liquid heating compartment 218. The plunger 258 is arranged to extend through the aperture 215 and, when the lid 204 is arranged on the container 202, into the liquid heating compartment 218.

The plunger 258 comprises a closure member, i.e. a sealing ring 216, extending around the outer surface of the plunger 258, for substantially closing the aperture 215 when the plunger 258 is in the lowered position. The sealing ring 216 is arranged on the plunger 258 such that the sealing ring 216 is moved into the aperture 215 to close the aperture 215 when the plunger 258 is in the lowered position, and is moved out of the aperture 215 to open the aperture 215 when the plunger 258 is in the raised position. Movement of the plunger therefore acts to selectively open/close the filling valve as formed by the aperture and 215 and closure member 216.

When the plunger 258 is in the raised position, liquid in the receiving chamber 214 is permitted to flow through the aperture 215 into the liquid heating compartment 218. However, when the plunger 258 is in the lowered position, liquid in the receiving chamber 214 is prevented from flowing into the liquid heating compartment 218, and steam is baffled or prevented from flowing into the receiving chamber 214 from the liquid heating compartment 218.

Thus, in a filling mode of operation in which the plunger 258 is arranged in the raised position, a user can fill the receiving chamber 214 with liquid, which will be permitted to flow through the aperture 215 into the liquid heating compartment 218. Conversely, in a heating mode of operation in which the plunger is arranged in the lowered position, the liquid heating compartment 218 is sealed from the receiving chamber 214 by the sealing ring 216 such that steam is baffled or prevented from flowing into the receiving chamber 214 from the liquid heating compartment 218.

In the embodiment seen in FIG. 7, the device 256 mounted to the plunger 258 can be the heater, e.g. a ferromagnetic heating plate as described in relation to FIGS. 5-6. Alternatively, an electrical resistance heater (not seen) can be arranged within the container 202, e.g. as described in relation to FIGS. 1-2.

What is claimed is:

1. A liquid heating appliance comprising:
a container defining a liquid heating compartment, a lid arranged over the container to cover the liquid heating compartment, and a heater operable to heat liquid within the liquid heating compartment;
wherein the lid defines a receiving chamber for receiving a volume of liquid, wherein the receiving chamber is a recessed feature of the lid and the receiving chamber comprises a non-return filling valve,
wherein:
the lid comprises a floor defining the base of the receiving chamber;
the non-return filling valve comprises a trough, arranged in the floor of the lid, and an opening in the base of the trough; and
the non-return filling valve is arranged, in a filling mode of the liquid heating appliance, to operate to allow liquid to flow through the opening from the receiving chamber into the liquid heating compartment and, in a heating mode of the appliance, the non-return filling valve is arranged to operate to substantially prevent fluid from flowing from the liquid heating compartment into the receiving chamber.

2. The liquid heating appliance of claim 1, wherein the lid comprises a funneled portion defining the receiving chamber.

3. The liquid heating appliance of claim 2, wherein the funneled portion comprises an inclined funnel floor that slopes downward towards the non-return filling valve such that liquid flowing down the funnel floor is directed into the non-return filling valve.

4-5. (canceled)

6. The liquid heating appliance of claim 1, wherein the trough comprises a U-shaped, V-shaped or Y-shaped cross-section.

7. The liquid heating appliance of claim 1, wherein the trough is sized to accommodate between 1 ml and 20 ml of liquid.

8. The liquid heating appliance of claim 1, wherein the non-return filling valve comprises a slit valve formed by one or more slits defined in the base of the trough.

9. (canceled)

10. The liquid heating appliance of claim 1, further comprising a plunger, arranged to extend through the lid into the liquid heating compartment and moveable vertically relative to the container between a lowered position and a raised position.

11-14. (canceled)

15. The liquid heating appliance of claim 10, wherein:
the appliance comprises a further filling valve comprising a valve aperture, provided in a floor of the receiving chamber, and a valve closure member;
the valve closure member is carried by the plunger; and
the plunger is arranged to extend through the valve aperture.

16-17. (canceled)

18. The liquid heating appliance of claim 10, wherein:
the plunger is arranged to extend through an aperture arranged centrally in a floor of the receiving chamber and into the liquid heating compartment; and
the non-return filling valve is arranged off-center in the floor of the receiving chamber.

19. The liquid heating appliance of claim 1, wherein the lid is removable.

20. The liquid heating appliance of claim 19, wherein the lid comprises a lifting feature for grasping and lifting to remove the lid from the container, wherein the lifting feature protrudes from a floor of the lid.

21. The liquid heating appliance of claim 1, wherein:
the lid is removable and comprises a lifting feature for grasping and lifting to remove the lid from the container;
the lifting feature protrudes from a floor of the lid;
the lifting feature is arranged centrally in the floor of the lid; and
the non-return filling valve is arranged off-center in the floor of the lid.

22. A liquid heating appliance comprising:
a container defining a liquid heating compartment, a lid arranged over the container to cover the liquid heating compartment, and a heater operable to heat liquid within the liquid heating compartment;
wherein the lid defines a receiving chamber for receiving a volume of liquid, and the receiving chamber comprises a filling valve,
wherein the filling valve is arranged, in a filling mode of the liquid heating appliance, to operate to allow liquid to flow from the receiving chamber into the liquid heating compartment and, in a heating mode of the appliance, the filling valve is arranged to operate to substantially prevent fluid from flowing from the liquid heating compartment into the receiving chamber; and
wherein the liquid heating appliance further comprises a plunger, arranged to extend through the lid into the liquid heating compartment and moveable vertically relative to the container between a lowered position and a raised position, wherein the plunger is arranged in the lowered position during the heating mode of the appliance, and arranged in the raised position during the filling mode of the appliance.

23. (canceled)

24. The liquid heating appliance of claim 22, wherein the heater comprises a ferromagnetic heating plate mounted to the plunger at a lower end of the plunger, and wherein the liquid heating appliance further comprises a thermally sensitive actuator and a lifting mechanism arranged to automatically move the ferromagnetic heating plate from the lowered position to the raised position when triggered by the thermally sensitive actuator.

25-26. (canceled)

27. The liquid heating appliance of claim 22, wherein:
the plunger is arranged to extend through an aperture arranged centrally in a floor of the receiving chamber and into the liquid heating compartment; and
the filling valve is arranged off-center in the floor of the receiving chamber.

28-29. (canceled)

30. The liquid heating appliance of claim 22, wherein:
the lid is removable and comprises a lifting feature for grasping and lifting to remove the lid from the container;
the lifting feature protrudes from a floor of the lid;
the lifting feature is arranged centrally in the floor of the lid; and
the filling valve is arranged off-center in the floor of the lid.

31. The liquid heating appliance of claim 22, wherein:
the filling valve comprises a valve aperture, provided in a floor of the receiving chamber, and a valve closure member;
the valve closure member is carried by the plunger; and
the plunger is arranged to extend through the valve aperture.

32. The liquid heating appliance of claim 31, wherein the valve closure member is arranged to selectively close the filling valve in the receiving chamber when the plunger is in the lowered position, and to selectively open the filling valve in the receiving chamber when the plunger is in the raised position.

33-36. (canceled)

37. The liquid heating appliance of claim 1, wherein the receiving chamber is uncovered.

38. The liquid heating appliance of claim 1, wherein the receiving chamber extends downwards from an aperture defined by the upper surface of the lid.

39-42. (canceled)
